(19) United States
(12) Patent Application Publication
(10) Pub. No.: US 2026/0244561 A1
(43) Pub. Date: Aug. 20, 2026

(54) MEMORY ACCESS INSTRUCTION REORDERING

(71) Applicant: ARM LIMITED, Cambridge (GB)

(72) Inventors: Richard Roy GRISENTHWAITE, Cambridge (GB); Thomas Philip SPEIER, Wake Forest, NC (US); Jade Ella Carla ALGLAVE, Cambridge (GB)

(21) Appl. No.: 19/054,088

(22) Filed: Feb. 14, 2025

(51) Int. Cl. G06F 12/02

(52) U.S. Cl. CPC G06F 12/0223

(57) ABSTRACT

An apparatus comprises processing circuitry to perform data processing and instruction decoding circuitry to decode instructions to control the processing circuitry. The processing circuitry imposes an ordering requirement on one or more memory access instructions to prevent said one or more memory access instructions being reordered with respect to an ordering instruction. In response to an ordering limit hint instruction associated with a given ordering instruction, the processing circuitry relaxes the ordering requirement for a memory access instruction for which the ordering limit hint instruction appears in program order between the memory access instruction and the given ordering instruction.

### BACKGROUND

### Technical Field

The present technique relates to the field of data processing.

### Technical Background

Data processing devices may receive program instructions (e.g., from memory) in an order corresponding to program order. To take advantage of cases where a younger instruction may be independent of an older instruction in program order which is stalled awaiting availability of operands, out-of-order issue may be supported such that a younger instruction is capable of bypassing an older instruction to allow the younger instruction to be issued for execution earlier than the older instruction.

### SUMMARY

At least some examples of the present technique provide an apparatus, comprising:
processing circuitry configured to perform data processing; and
instruction decoding circuitry configured to decode instructions to control the processing circuitry to perform the data processing; in which:
the processing circuitry is configured to impose an ordering requirement on one or more memory access instructions to prevent said one or more memory access instructions being reordered with respect to an ordering instruction; and
in response to an ordering limit hint instruction associated with a given ordering instruction, the instruction decoding circuitry is configured to control the processing circuitry to relax the ordering requirement for a memory access instruction for which the ordering limit hint instruction appears in program order between the memory access instruction and the given ordering instruction.

At least some examples provide computer-readable code for fabrication of the apparatus described above. The code may be stored on a non-transitory computer-readable medium.

At least some examples provide a method, comprising:
performing data processing; and
decoding instructions to control performing the data processing;
imposing an ordering requirement on one or more memory access instructions to prevent said one or more memory access instructions being reordered with respect to an ordering instruction; and
in response to an ordering limit hint instruction associated with a given ordering instruction, relaxing the ordering requirement for a memory access instruction for which the ordering limit hint instruction appears in program order between the memory access instruction and the given ordering instruction.

At least some examples provide a computer program comprising instructions which, when executed by a host data processing apparatus, control the host data processing apparatus to provide an instruction execution environment for execution of target program code, the computer program comprising:
processing program logic configured to perform data processing; and
instruction decoding program logic configured to decode instructions of the target program code to control the processing program logic to perform the data processing; in which:
the processing program logic is configured to impose an ordering requirement on one or more memory access instructions to prevent said one or more memory access instructions being reordered with respect to an ordering instruction; and
in response to an ordering limit hint instruction associated with a given ordering instruction, the instruction decoding program logic is configured to control the processing program logic to relax the ordering requirement for a memory access instruction for which the ordering limit hint instruction appears in program order between the memory access instruction and the given ordering instruction.

The computer program may be provided on a non-transitory computer-readable medium.

Further aspects, features and advantages of the present technique will be apparent from the following description of examples, which is to be read in conjunction with the accompanying drawings.

### BRIEF DESCRIPTION OF THE DRAWINGS

FIG. 1 schematically illustrates an example of a data processing apparatus;

FIGS. 2 and 3 illustrate an ordering instruction and an ordering limit hint instruction;

FIG. 4 illustrates an example of a data memory barrier instruction and ordering limit hint instructions;

FIG. 5 illustrates an example of a load-acquire instruction and acquire limit hint instruction;

FIG. 6 illustrates an example of a store-release instruction and release limit hint instruction;

FIGS. 7 and 8 illustrate the use of load-acquire and store-release instructions to surround a critical code section;

FIG. 9 illustrates use of a hint counter for nested ordering limit hint instructions;

FIGS. 10 and 11 illustrate an example of a conditional control flow instruction as an ordering instruction;

FIG. 12 illustrates a method of imposing an ordering requirement; and

FIG. 13 illustrates a simulation example.

### DESCRIPTION OF EXAMPLES

In accordance with some example embodiments, there is provided an apparatus comprising processing circuitry configured to perform data processing, and instruction decoding circuitry configured to decode instructions to control the processing circuitry to perform the data processing. The instruction decoding circuitry decodes instructions according to a program order, but the processing circuitry may issue instructions for execution in an order different to the order in which they are decoded. For instance, a younger instruction decoded later than an older instruction may be issued before the older instruction, for example if the older instruction is waiting for an operand to become available (e.g., waiting for data to be returned from memory), as long as the younger instruction is not dependent on the older instruction. Out of order execution may be speculative and instructions may be committed in program order. By enabling out-of-order execution, the processing circuitry may provide improved performance, because younger instructions may be executed during delays affecting older instructions.

In certain situations, even in a processor supporting out-of-order execution, there may be a requirement for certain instructions to be executed in program order. In particular, there may be a requirement for certain memory access instructions to be executed in program order (that is, a requirement for the memory accesses generated by those memory access instructions to be performed in program order) to avoid incorrect execution. Therefore, the processing circuitry is configured to support imposing an ordering requirement to ensure that certain instructions are not reordered with respect to each other. In particular, the processing circuitry is configured to impose an ordering requirement on one or more memory access instructions to prevent said one or more memory access instructions being reordered with respect to an ordering instruction.

The one or more memory access instructions on which the ordering requirement is imposed may vary in different examples. For example, the ordering requirement could apply to all memory access instructions in a program, or only a selection of memory access instructions. For example, the ordering requirement may apply to certain types of memory access instruction (e.g., only load instructions, or only store instructions). The ordering requirement may apply to certain instructions in the program, such as only instructions preceding, or following, the ordering instruction in program order. Instructions on which the ordering requirement is not imposed may be reordered with respect to the ordering instruction.

Preventing reordering of a given memory access instruction with respect to the ordering instruction may comprise requiring the given memory access instruction and the ordering instruction to be executed in program order, in which executing a memory access instruction comprises performing the memory access generated by a memory access instruction. That is, if the given memory access instruction appears in program order before the ordering instruction then the ordering requirement may require that the given memory access instruction is executed (the memory access generated by the given memory access instruction is performed) before the ordering instruction, and if the given memory access instruction appears in program order after the ordering instruction then the ordering requirement may require that the given memory access instruction is executed after the ordering instruction. A memory access instruction on which the ordering requirement is imposed may be reordered with respect to instructions other than the ordering instruction, as long as the memory access instruction is not reordered with respect to the ordering instruction. However, it will be appreciated that if an ordering requirement is imposed on instructions before and after an ordering instruction, then a consequence of preventing reordering of each of those instructions with respect to the ordering instruction is that those instructions cannot be reordered with respect to each other.

Various instructions may be treated as an ordering instruction by the processing circuitry. In some examples, the ordering instruction may be a dedicated instruction included by a programmer for imposing an ordering requirement (e.g., a data barrier instruction, as discussed below) or an ordering requirement may be implicitly imposed for certain instructions which may be treated as ordering instructions (e.g., a conditional control flow instruction may impose an ordering requirement on later instructions).

The inventors have realised that in many cases ordering instructions may impose an ordering requirement on a larger number of instructions than is necessary to meet the purpose of the ordering requirement, and that this may impact processing performance. As an illustrative example, an ordering requirement for a given ordering instruction may be imposed on all memory access instructions in a program, but the ordering requirement may only be relevant for memory access instructions close to the ordering instruction in program order, and it may be possible to reorder memory access instructions which are much earlier or later than the ordering instruction with respect to the ordering instruction without causing errors. The inventors have realised that imposing broadly defined ordering requirements may therefore impact performance, as this may unnecessarily prevent certain out-of-order execution of instructions which might have otherwise increased performance of the processor.

Processors may re-order instructions within an out-of-order window of instructions. The out-of-order window may for example correspond to the instructions currently represented by a re-order buffer. Many modern processors allow instruction reordering over increasingly large out-of-order windows, and the inventors have realised that the performance impacts of ordering requirements can be more problematic as the size of the out-of-order window increases. In particular, in processors having larger out-of-order windows, the out-of-order window may include a larger number of instructions which could be reordered with respect to the ordering instruction without causing errors (e.g., there may be a larger number of instructions in the out-of-order window further away from the ordering instruction in program order), but which are nevertheless prevented from reordering (and the resulting performance improvements) due to the ordering requirement.

According to examples of the present technique, the instruction decoding circuitry is responsive to an ordering limit hint instruction associated with a given ordering instruction to control the processing circuitry to relax the ordering requirement for a memory access instruction for which the ordering limit hint instruction appears in program order between the memory access instruction and the given ordering instruction. That is, the processing circuitry does not impose the ordering requirement, associated with the given ordering instruction, on memory access instructions which are separated from the given ordering instruction in program order by the ordering limit hint instruction. The ordering limit hint instruction therefore identifies a boundary of the ordering requirement for the given ordering instruction. The ordering requirement associated with a given ordering instruction is imposed for a section of code delimited by the ordering limit hint instruction associated with the given ordering instruction.

Providing an ordering limit hint instruction enables a programmer to indicate to the processing circuitry a point in a program at which a particular ordering requirement for a given ordering instruction is no longer required for correct execution, and that instructions beyond the ordering limit hint instruction may be reordered with respect to the given ordering instruction without introducing processing errors. Without such an instruction, as discussed above, the processor may be unaware that the ordering requirement is not required for certain instructions, and hence may impose the ordering requirement on instructions unnecessarily. As a result of the instruction decoding circuitry supporting an ordering limit hint instruction, the processing circuitry can execute instructions with improved performance because a greater proportion of instructions may be executed out of order.

An ordering limit hint instruction may be associated with a given ordering instruction in various ways. For example, in a simple example each ordering limit hint instruction may be considered to be associated with the next ordering instruction in program order or the previous ordering instruction in program order. An ordering limit hint instruction could also be associated with two or more ordering instructions, such as both the next and previous ordering instructions in program order.

However, in some examples, an encoding of the ordering limit hint instruction may enable the given ordering instruction to be identified. For example, there may be several ordering instructions within the same portion of a program having overlapping regions in which an ordering requirement is required, and the encoding of an ordering limit hint instruction may allow the processing circuitry to associate a particular ordering limit hint instruction with a particular ordering instruction.

For example, an encoding of the ordering limit hint instruction may identify whether the given ordering instruction appears in program order earlier or later than the ordering limit hint instruction. For example, two classes of ordering limit hint instruction may be provided, with one class indicating to the processing circuitry that it is associated with an ordering instruction later in program order and the other class indicating to the processing circuitry that it is associated with an ordering instruction earlier in program order. The opcode of, or an operand specified by, the ordering limit hint instruction may be used to determine whether that ordering limit hint instruction is associated with an ordering limit earlier in program order or later in program order than the ordering limit hint instruction. Therefore, if a particular ordering limit hint instruction appears in a program between two ordering instructions, the encoding of the ordering limit hint instruction enables the processing circuitry to determine which of those ordering instructions is associated with the ordering limit hint instruction.

In some examples, the encoding of the ordering limit hint instruction may alternatively or additionally identify an instruction type of the given ordering instruction. For example, different types of ordering limit hint instruction may be provided for specific types of ordering instructions. An encoding of an ordering limit hint instruction may therefore indicate to the processing circuitry that the processing circuitry should associate that ordering limit hint instruction with an ordering instruction of a particular type (e.g., the next or previous ordering instruction in program order of the particular type). Different ordering limit hint instructions having different opcodes may be provided, for each type of ordering instruction, or an operand specified by the ordering limit hint instruction may identify a particular type of ordering instruction.

In some examples, the processing circuitry may be configured to associate an ordering limit hint instruction with an ordering instruction only when the ordering instruction is identified as a limited-ordering type of ordering instruction. A limited-ordering type of ordering instruction may be identified using a limited ordering prefix instruction. In particular, the instruction decoding circuitry may be responsive to a limited ordering prefix instruction to identify that a subsequent ordering instruction (e.g., the next ordering instruction in program order) is a limited-ordering ordering instruction. Providing a limited ordering prefix instruction enables a programmer to identify ordering instructions for which the ordering requirement can be limited. This can for example simplify the process of associating ordering limit hint instructions with ordering instructions, as ordering instructions which are not of the limited-ordering type can be excluded from consideration.

As discussed above, the ordering instruction may take a variety of forms. In some examples, the processing circuitry may be configured to treat at least one type of memory barrier instruction as an ordering instruction. The processing circuitry may be configured to impose the ordering requirement on memory access instructions appearing in program order on at least a first side of the memory barrier instruction (where the first side may be before or after the memory barrier instruction in program order). Hence, the ordering requirement imposed by a memory barrier instruction may prevent memory access instructions on at least one side of the memory barrier instruction from being reordered with respect to the memory barrier instruction (i.e., prevent those instructions from being reordered to the second side of the memory barrier instruction). Such data memory barrier instructions may be widely used in programs as they can be used by a programmer to ensure that certain memory accesses are performed in a particular order, and in particular can be used to support certain memory consistency models.

However, an issue with memory barrier instructions is that typical implementations prevent any memory access instruction (e.g., loads and stores) on the first side of the memory barrier instruction from being reordered with respect to the memory barrier instruction, regardless of the distance from the memory barrier instruction. In addition, while a memory barrier instruction may be included to enforce a particular order of accesses for memory access instructions accessing a particular region of memory, the memory barrier instruction prevents reordering of memory access instructions even if they are for accessing regions of memory completely separate from the particular region of memory. Hence, a memory barrier instruction is an ordering instruction which gives rise to the problems addressed by the present techniques.

According to the present techniques, relaxing the ordering requirement for a given memory access instruction appearing in program order on the first side of the memory barrier instruction comprises permitting the given memory access instruction to be reordered to a second side of the memory barrier instruction. That is, an ordering limit hint instruction may be included in a program on the first side of the memory barrier instruction to indicate a limit to the ordering requirement. The ordering requirement may therefore be imposed on memory access instructions appearing in program order on the first side of the memory barrier instruction between the ordering limit hint instruction and the memory barrier instruction. A programmer may include the ordering limit hint instruction in a program to indicate that memory access instructions further from the memory barrier instruction than the ordering limit hint instruction do not need to have the ordering limit imposed, for example as they may act on a region of memory separate from the region of memory accessed by memory access instructions for which a particular order is imposed by the memory barrier instruction.

Memory barrier instructions may take a variety of forms. In some examples, the at least one type of memory barrier instruction may comprise a general memory barrier instruction and the processing circuitry may be configured to also impose the ordering requirement on memory access instructions appearing in program order on a second side of the general memory barrier instruction (in addition to imposing the ordering requirement on memory access instructions appearing on the first side of the general memory barrier instruction). Therefore, instructions both preceding and following the general memory barrier instruction may not be reordered with respect to the general memory barrier instruction, and the ordering requirement (absent any ordering limit hint instructions) means that any memory access generated by a memory access instruction before the general memory barrier instruction must be observed before any memory access generated by a memory access instruction after the general memory barrier instruction.

The at least one type of memory barrier instruction may also comprise a one-way memory barrier instruction, for which the processing circuitry may be configured not to impose an ordering requirement on memory access instructions on the second side of the one-way memory barrier instruction. A one-way memory barrier may reduce some of the performance impacts associated with a general memory barrier, but the ordering requirement of a one-way memory barrier may nevertheless be associated with performance impacts due to the restricted ordering for all memory access instructions on the first side of the one-way memory barrier instruction.

In some examples, the at least one type of memory barrier instruction may comprise an acquire instruction. The processing circuitry may be configured to impose the ordering requirement on memory access instructions appearing in program order after the acquire instruction, but may not impose an ordering requirement on instructions appearing in program order before the acquire instruction, and therefore the acquire instruction may provide a one-way barrier preventing subsequent memory access instructions from being reordered before the acquire instruction, that is, preventing memory accesses generated by subsequent memory access instructions from being observed before the acquire instruction. The instruction decoding circuitry may be responsive to decoding of the acquire instruction to control the processing circuitry to load a target value identified by the acquire instruction (such an acquire instruction being referred to as a load-acquire instruction), and hence the acquire instruction may be used to ensure that the load of the target value is observed before any subsequent memory accesses. An acquire instruction may be used in a processor using acquire and release semantics, such as processors using a release consistency sequentially consistent consistency model.

An acquire instruction may for example be used when entering a critical section of code, to ensure that memory accesses in the critical section of code cannot be re-ordered before the start of the critical section of code. However, the effects of the acquire instruction may persist beyond the end of the critical section of code and unnecessarily prevent later instructions from being reordered with respect to the acquire instruction. Therefore, an ordering limit hint instruction may be included in a program after the end of a critical section of code. The processing circuitry may be configured to relax the ordering requirement for memory access instructions appearing in program order after an ordering limit hint instruction associated with the acquire instruction, and therefore this can allow later instructions to be reordered with respect to the acquire instruction. Therefore, loads/stores that appear in program order after an ordering limit hint instruction that is in program order after an acquire instruction can proceed without waiting for the earlier instructions to complete.

In some examples, the at least one type of memory barrier instruction may comprise a release instruction. The processing circuitry may be configured to impose the ordering requirement on memory access instructions appearing in program order before the release instruction, but may not impose an ordering requirement on instructions appearing in program order later than the release instruction, and therefore the release instruction may provide a one-way barrier preventing earlier memory access instructions from being reordered after the release instruction, that is, preventing memory accesses generated by the earlier memory access instructions from being observed after the release instruction. The instruction decoding circuitry may be responsive to decoding of the release instruction to control the processing circuitry to store a target value identified by the release instruction (such a release instruction being referred to as a store-release instruction), and hence the release instruction may be used to ensure that the store of the target value is observed after all preceding memory accesses. A release instruction may be used in a processor using acquire and release semantics.

A release instruction may for example be used at the end of a critical section of code, to ensure that memory accesses in the critical section of code cannot be re-ordered after the end of the critical section of code, and the effects of the memory accesses in the critical section are therefore reflected in any final results of the critical section of code. However, the effects of the release instruction may extend beyond the start of the critical section of code and unintentionally prevent earlier instructions from being reordered with respect to the release instruction. Therefore, an ordering limit hint instruction may be included in a program before the start of a critical section of code. The processing circuitry may be configured to relax the ordering requirement for memory access instructions appearing in program order before an ordering limit hint instruction associated with the release instruction, and therefore this can allow earlier instructions to be reordered with respect to the release instruction. Therefore, the store-release can complete without waiting for the completion of all loads/stores appearing in program order before the ordering limit hint instruction appearing in program order before the release instruction.

Hence, some examples may provide an acquire instruction to mark the start of a critical section of code and a release instruction to mark the end of a critical section of code. An ordering limit hint instruction may be used after the end of the critical section of code to mark the limit of the acquire instruction and an ordering limit hint instruction may be used before the start of the critical section of code to mark the limit of the release instruction.

The end of a critical section of code may therefore include both a release instruction and an ordering limit instruction associated with the earlier acquire instruction. In some examples, the at least one type of memory barrier instruction may comprise an ordering limit variant of a release instruction, and the processing circuitry may be configured to impose an ordering requirement on memory access instructions appearing in program before the ordering limit variant of the release instruction to prevent said memory access instructions being reordered with respect to the ordering limit variant of the release instruction, and treat the ordering limit variant of the release instruction as the ordering limit hint instruction associated with an acquire instruction appearing earlier in program order than the ordering limit variant of the release instruction. Therefore, to increase code density a single instruction may provide both the release instruction marking the end of a critical section of code and the ordering limit hint instruction for the acquire instruction at the start of the critical section of code.

Similarly, the start of a critical section of code may include both an acquire instruction and an ordering limit hint instruction associated with the later release instruction. In some examples, the at least one type of memory barrier instruction may further comprise an ordering limit variant of an acquire instruction, and the processing circuitry may be configured to impose an ordering requirement on memory access instructions appearing in program after the ordering limit variant of the acquire instruction to prevent said memory access instructions being reordered with respect to the ordering limit variant of the acquire instruction, and treat the ordering limit variant of the acquire instruction as the ordering limit hint instruction associated with a release instruction appearing later in program order than the ordering limit variant of the acquire instruction. Therefore, to increase code density a single instruction may provide both the acquire instruction marking the start of a critical section of code and the ordering limit hint instruction for the release instruction at the end of the critical section of code.

The ordering limit variants of the acquire and release instructions may have separate encodings from the normal acquire and release instructions, enabling for backwards compatibility with code written without intending acquire and release instructions to be interpreted as ordering limit hint instructions.

In some examples, the ordering instruction may include instructions other than an explicit memory barrier. For example, the processing circuitry may be configured to treat at least one type of conditional control flow instruction as the ordering instruction. A conditional control flow instruction (e.g., a conditional branch instruction) may cause a program to take one of two paths depending on the condition of the control flow instruction. The processing circuitry may impose an ordering requirement to prevent memory access instructions appearing in the program order after the conditional control flow instruction from being reordered before the conditional control flow instruction, in case that memory access instruction is on a not taken path which does not form part of the architecturally correct execution following the conditional control flow instruction. However, certain later memory access instructions may occur in the program after the conditional paths have converged, and therefore may be executed regardless of the outcome of the conditional control flow instruction. In this case those memory access instructions could be reordered with respect to the conditional control flow instruction without leading to incorrect execution. By providing a limited ordering hint instruction, this enables a programmer to indicate to the processing circuitry a point in a program beyond which an ordering requirement implied by a conditional control flow instruction is no longer required (e.g., the point at which both paths converge), which can allow those later memory access instructions to be reordered for improved performance.

It will be appreciated that various microarchitectural implementations may be used to achieve the architectural behaviour described above.

When the processing circuitry imposes an ordering requirement on instructions appearing in program order on at least one side of an ordering instruction, then the processing circuitry could compare the age (within the program order, e.g., indicated by a position in the reorder buffer) of a given memory access instruction with the age of each relevant ordering instruction to determine whether said given memory access instruction is older or younger than the given ordering instruction and hence whether said memory access instruction can be reordered with respect to the ordering instruction. Within such an implementation, the age of an ordering limit hint instruction may be considered as a further comparison for each reordering decision. That is, the given memory access instruction may be compared against the age of both an ordering instruction and an ordering limit hint instruction associated with that ordering instruction. If the memory access instruction is younger or older than both the hint and the ordering instruction then it may for example be determined that the ordering requirement does not apply to that memory access instruction, but if the memory access instruction is younger than one of the hint/ordering instruction and older than the other then it may be determined that the ordering limit still applies to the given memory access instruction.

In one example implementation, the apparatus may comprise a hint counter associated with a given ordering instruction. A hint counter may be associated with an ordering instruction in various ways. For example, a single hint counter may be provided applying to all ordering instructions, a hint counter may be provided per instruction type, and so on. Which approach is used for associating a hint counter with an ordering instruction may depend on an approach used to associate ordering limit hint instructions with ordering instructions. Hint tracking circuitry may be provided to update the hint counter (e.g., increment the hint counter) in response to the instruction decoding circuitry decoding an ordering limit hint instruction associated with the given ordering instruction. The value of the hint counter therefore identifies regions of code for which an ordering requirement may be applied differently (e.g., instructions in each region of code may be treated in the same way as each other, and in a different way to a region of code having a different value). The processing circuitry may therefore select whether to impose the ordering requirement, associated with the given ordering instruction, on a given memory access instruction based on a value of the hint counter at a time the given memory access instruction is decoded by the instruction decoding circuitry.

Depending on whether the ordering instruction acts as a one-way barrier or not, the processing circuitry may also be configured to update the hint counter in a second direction (e.g., decrement the hint counter) in response to the instruction decoding circuitry decoding the given ordering instruction.

To provide a simple example, a hint counter may start at the value zero. An ordering limit hint instruction may be decoded causing the hint counter to be incremented to one, and then a memory barrier instruction may be decoded. Instructions decoded whilst the hint counter was one may be subjected to the ordering requirement, and instructions decoded whilst the hint counter was zero may not be subjected to the ordering requirement. If the memory barrier instruction was a one-way barrier, it may cause the hint counter to be decremented to zero, and therefore any instruction following the one-way memory barrier instruction may not be subjected to the ordering requirement. It will be appreciated that this example may be subjected to many variations, but serves to illustrate the principle of a hint counter for separating code into regions for deciding whether to apply an ordering requirement.

In some examples, the hint counter may comprise at least three states (e.g. it may be provided using two or more bits). A hint counter having at least three states may provide one implementation supporting nesting of ordering limit hint instructions, in which an associated pair of an ordering limit hint instruction and ordering instruction may be provided between a further associated pair of an ordering limit hint instruction and an ordering instruction, as by supporting three or more states the hint counter is able to indicate two or more levels of nesting.

In some examples, the processing circuitry may be responsive to a hint clear trigger to suppress the effects of the ordering limit hint instruction associated with the given ordering instruction. For example, in various implementations an ordering limit hint instruction may indicate to the processing circuitry to change the behaviour of the next ordering instruction encountered in the program. However, if after decoding the ordering limit hint instruction an exception is triggered, then the pending hint could have unintended consequences on any ordering instructions in the exception handler. There may be various other similar situations where a hint could persist after a change in processing and have unintended side effects. By supporting a hint clear trigger, the processing circuitry can allow such side effects to be mitigated. For example, taking an exception may be treated as a hint clear trigger, causing the effects of any pending hints to be suppressed so the exception can be handled correctly. The hint clear trigger could also be provided by a change in execution mode, or could be directly triggered by software. For example, the instruction decoding circuitry may be responsive to a hint clear instruction to control the processing circuitry to suppress the effects of the ordering limit hint instruction. Such an instruction could be included at the start of an exception handler to clear any pending ordering limit hint instructions so they do not affect the exception handler.

The ordering limit hint instruction may enable performance to be improved, but correct architectural execution of code may still be achieved if the ordering limit hint instruction is ignored by the processing circuitry. This means that code written to include ordering limit hint instructions may be backwards-compatible, and correctly executed on existing hardware not supporting the ordering limit hint instruction, as long as the hardware does not incorrectly interpret the ordering limit hint instruction as another type of instruction. Therefore, in some examples, an ordering limit hint instruction may be encoded within a no-operation space of a legacy instruction set architecture supported by the instruction decoding circuitry. Hardware designed for the legacy instruction set architecture may therefore ignore the ordering limit hint instructions (they may trigger no operation to be performed) without causing incorrect execution.

Providing ordering limit hint instructions in the no-operation space of a legacy instruction set architecture also means that code written for the legacy instruction set architecture is compatible with hardware designed to support the ordering limit hint instructions. In particular, whilst hardware designed to support the ordering limit hint instruction could interpret existing encodings of instructions in the legacy instruction set architecture to also act as ordering limit hint instructions (e.g., acquire instructions could be interpreted as an ordering limit variant of an acquire instruction), doing so means that legacy code could be executed incorrectly by inferring an ordering limit hint instruction where it was not intended by the original programmer. By only using encodings for the ordering limit hint instructions instruction which would not have been used in legacy code, hardware designed to support the ordering limit hint instructions may still support correct execution of legacy code.

In a similar way, the limited ordering prefix instruction may also be defined within the no-operation space of the legacy instruction set architecture.

Particular examples will now be described with reference to the Figures.

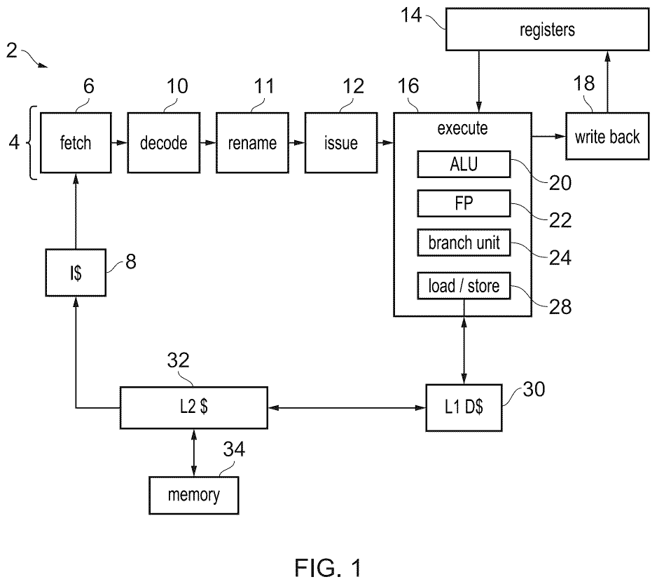

FIG. 1 schematically illustrates an example of a data processing apparatus 2. The data processing apparatus has a processing pipeline 4 which includes a number of pipeline stages. In this example, the pipeline stages include a fetch stage 6 for fetching instructions from an instruction cache 8; a decode stage 10 for decoding the fetched instructions; a rename stage 11 for mapping architectural registers specified by instructions to physical register specifiers identifying physical registers in a register file 14, an issue stage 12 for issuing instructions for execution, an execute stage 16 for executing the issued instructions; and a writeback stage 18 for writing the results of the processing back to the register file 14. It will be appreciated that this is merely one example of possible pipeline architecture, and other systems may have additional stages or a different configuration of stages.

The execute stage 16 includes a number of processing units, for executing different classes of processing operation. For example the execution units may include an arithmetic/logic unit (ALU) 20 for performing arithmetic or logical operations; a floating-point unit 22 for performing operations on floating-point values, a branch unit 24 for evaluating the outcome of branch operations and adjusting the program counter which represents the current point of execution accordingly; and a load/store unit 28 for performing load/store operations to access data in a memory system 8, 30, 32, 34. In this example the memory system include a level one data cache 30, the level one instruction cache 8, a shared level two cache 32 and main system memory 34. It will be appreciated that this is just one example of a possible memory hierarchy and other arrangements of caches can be provided. The specific types of processing unit 20 to 28 shown in the execute stage 16 are just one example, and other implementations may have a different set of processing units or could include multiple instances of the same type of processing unit so that multiple micro-operations of the same type can be handled in parallel. It will be appreciated that FIG. 1 is merely a simplified representation of some components of a possible processor pipeline architecture, and the processor may include many other elements not illustrated for conciseness, such as branch prediction mechanisms or address translation or memory management mechanisms.

The pipeline 4 is an out-of-order pipeline which supports execution of instructions in a different order to the program order in which the instructions were fetched by the fetch stage 6. The issue stage 12 has an issue queue for queuing instructions to be executed while waiting for their operands to become available. When an instruction's operands become available (or are guaranteed to become available in time for the pipeline stage at which the operands are needed), then it may be issued for execution by the execute stage 16 even if an earlier instruction in the program order is still waiting for its operands. To increase the extent to which reordering of instructions is possible, the rename stage 11 is provided to map architectural register specifiers specified by the fetched instructions to physical register specifiers identifying physical registers 14 provided in hardware. Typically the number of physical registers provided is greater than the number of architectural registers available in the instruction set architecture, to allow different instructions specifying the same architectural register to be mapped to different physical registers so that dependencies between these instructions can be eliminated. This permits greater flexibility to reorder the execution of instructions, to improve performance. The rename stage 11 maintains a rename table for tracking the mapping between architectural register specifiers and physical register specifiers. A reorder buffer is also provided to track completion of instructions that have been executed out-of-order, and can be used to determine when the completed instructions are ready to commit in program order.

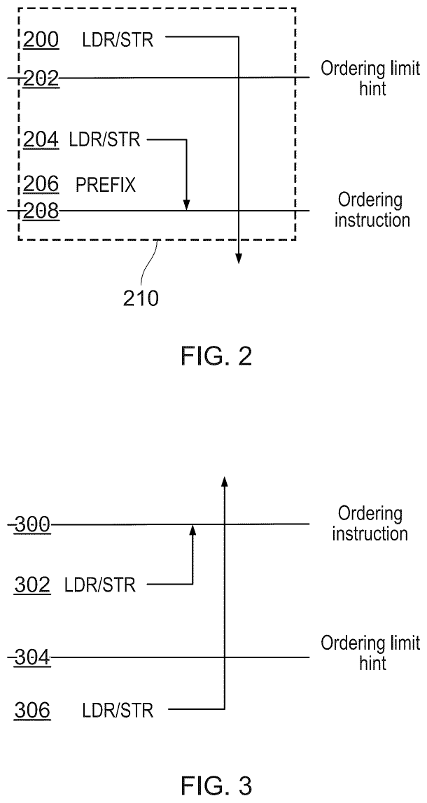

FIGS. 2 to 11 illustrate sections of code shown in program order. In FIGS. 2 to 11, program order is shown from top down, such that the oldest instruction (decoded earliest) is shown at the top of Figure and instructions become younger (decoded later) going down the Figure. For ease of illustration, FIGS. 2 to 9 do not show the majority of instructions in the program, and instead only illustrate certain relevant instructions.

FIG. 2 illustrates memory access instructions 200 and 204 (which could be either of a load instruction LDR or a store instruction STR), an ordering limit hint instruction 202, an ordering instruction 208, and a limited ordering prefix instruction (labelled PREFIX) 206.

The ordering instruction 208 shown in FIG. 2 is associated with an ordering requirement preventing memory access instructions appearing in program order earlier than the ordering instruction 208 from being reordered after the ordering instruction 208. The ordering instruction could for example be a general data memory barrier instruction, a one-way memory barrier, and so on. The memory access instruction 204 is prevented from being re-ordered after the ordering instruction 208, as illustrated using an arrow from the memory access instruction 204 terminating at the ordering instruction 208. The memory access instruction 204 may therefore be reordered later than in program order (and may therefore be executed after certain instructions younger than itself), but cannot be reordered any later than the ordering instruction 208. It will be appreciated that FIG. 2 only illustrates the extent to which the memory access instruction 204 can be reordered later than in program order, and does not show the extent to which the memory access instruction 204 can be reordered earlier than in program order, which is not relevant in this illustration.

FIG. 2 illustrates an ordering limit hint instruction 202 associated with the ordering instruction 208. The ordering limit hint instruction 202 identifies a boundary of the ordering requirement associated with the ordering instruction 208. The ordering requirement is not imposed on memory access instruction for which the ordering limit hint instruction appears in program order between the memory access instruction and the given ordering instruction. Therefore, although the memory access instruction 200 is earlier in program order than the ordering instruction 208 (and would therefore otherwise be prevented from being reordered later than the ordering instruction 208 by the ordering requirement associated with the ordering instruction 208), because the ordering limit hint instruction 202 associated with the ordering instruction 208 appears in program order between the memory access instruction 200 and the ordering instruction 208, the processing circuitry does not impose the ordering requirement on the memory access instruction 200. Therefore, as illustrated in FIG. 2, the memory access instruction 200 can be re-ordered after the ordering instruction 208.

Therefore, FIG. 2 shows that the processing circuitry imposes the ordering requirement only on a region of code with a boundary indicated by the ordering limit hint instruction 202. This can allow performance to be improved, because it reduces the re-ordering restrictions imposed on instructions separated far from the ordering instruction 208 in program order and allow more options for performance improving reordering. A programmer may for example include the ordering limit hint instruction 202 to identify a point beyond which the ordering requirement of the ordering instruction 208 is no longer relevant.

FIG. 2 illustrates a limited ordering prefix instruction 206. The limited ordering prefix instruction 206 indicates to the processing circuitry that the following ordering instruction 208 is an ordering instruction with a limited range, and is hence an ordering instruction for which there is at least one associated ordering limit hint instruction 202. FIGS. 3 to 11 do not explicitly show a limited ordering prefix instruction 206 for clarity, but it will be appreciated that each of the ordering instructions shown in those Figures may be preceded by a limited ordering prefix instruction.

FIG. 2 also schematically illustrates an out-of-order window 210 (also termed an instruction window). Instructions enter the out-of-order window (when decoded) and leave the out-of-order window (when committed) in program order (e.g., enter from the bottom and leave from the top in FIG. 2), but within the out-of-order window may be executed out-of-order, subject to any ordering requirements. It will be appreciated that, with a smaller out-of-order window, the ordering requirement of the ordering instruction 208 may present fewer problems, as most instructions in the out-of-order window at the same time as the ordering instruction 208 may be instructions which the programmer intends to be ordered with respect to the ordering instruction. However, many modern processors are providing increasingly larger out-of-order windows. With a larger out-of-order window (e.g., as shown in FIG. 2) an out-of-order window including an ordering instruction 208 is more likely to also include memory access instructions 200 which could (while maintaining correct execution) be re-ordered with respect to the ordering instruction 208 but which (without considering the ordering limit hint instruction) are prevented from being reordered by the ordering requirement. FIG. 2 therefore illustrates that the advantages provided by the ordering limit hint instruction, of providing increased opportunities for re-ordering of instructions, become more significant as the size of the out-of-order window is increased.

FIG. 3, similarly to FIG. 2, illustrates an ordering instruction 300 and an ordering limit hint instruction 304. Compared to FIG. 2, the ordering instruction 300 of FIG. 3 is associated with an ordering requirement imposed on memory access instructions following the ordering instruction 300 in program order. For example, the memory access instruction 302 appearing in program order after the ordering instruction 300 is prevented from being reordered before the ordering instruction 300 in program order.

The memory access instruction 306 appears in program order after the ordering instruction 300, but the ordering requirement is not imposed on the memory access instruction 306 because the ordering limit hint instruction appears in program order between the ordering instruction 300 and the memory access instruction 306. The memory access instruction 306 can therefore be reordered before the ordering instruction 300.

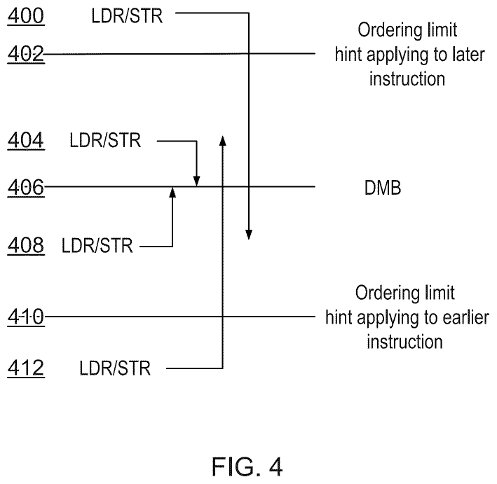

FIG. 4 illustrates a general data memory barrier (DMB) instruction 406 for which the processing circuitry imposes an ordering requirement on memory access instructions before and after the DMB instruction 406. For instructions affected by the ordering requirement, memory access instructions 404 before the DMB instruction 406 cannot be reordered after the DMB instruction, and memory access instructions 408 after the DMB instruction 406 cannot be reordered before the DMB instruction. Therefore, the DMB instruction requires that the preceding memory access instruction 404 is executed before the following memory access instruction 408, which can be beneficial when there is a requirement for those instructions to be executed in program order (e.g., if they access the same region of memory). However, the effects of the DMB instruction may extend over the whole program so that earlier instructions, such as the earlier memory access instruction 400, and later instructions, such as the later memory access instruction 412, would typically also be impacted by the DMB instruction 406. However, the effects of the DMB instruction can be limited to a certain portion of a program using ordering limit hint instructions.

FIG. 4 illustrates a first ordering limit hint instruction 402 which is associated with an ordering instruction later in program order, and a second ordering limit hint instruction which is associated with an ordering instruction earlier in program order. In the example of FIG. 4, the processing circuitry associates both ordering limit hint instructions with the DMB instruction 406. Therefore, the earlier memory access instruction 400, which appears in program order earlier than both the ordering limit hint 402 and the DMB 406, is not affected by the ordering requirement of the DMB instruction 406 and can be reordered later than the DMB instruction. Similarly, the later memory access instruction 412, which appears in program order later than both the DMB instruction 406 and the ordering limit hint 410, can be reordered earlier than the DMB instruction.

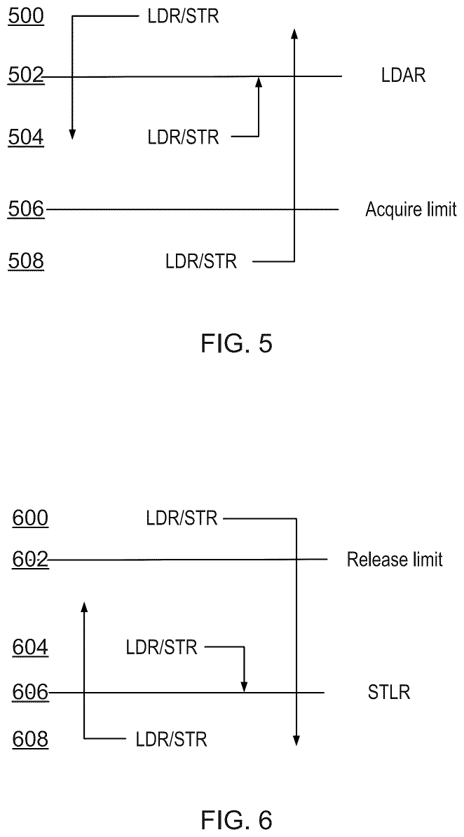

FIG. 5 illustrates a load-acquire instruction LDAR 502, which acts as a one-way barrier. The LDAR instruction 502 causes a target value to be loaded from a memory location identified by the LDAR instruction 502. Memory access instructions after the LDAR are subject to an ordering requirement requiring that they are observed after the LDAR instruction 502, but all memory access instructions before the LDAR can be reordered with respect to the LDAR. Therefore, memory access instruction 500 appearing before the LDAR instruction 502 in program order may be reordered after the LDAR instruction 502. However, memory access instruction 504 appearing after the LDAR instruction 504 cannot be reordered before the LDAR instruction 502.

FIG. 5 illustrates an ordering limit hint instruction 506 associated with the LDAR instruction. The ordering limit hint instruction 506 in FIG. 5 is an acquire limit, and may be provided with its own opcode. The processing circuitry may associate the acquire limit with the closest preceding LDAR instruction in program order. The effect of the acquire limit is that memory access instructions appearing after the acquire limit in program order, such as memory access instruction 508, can be reordered before the LDAR instruction 502 associated with that acquire limit instruction.

FIG. 6 illustrates a store-release instruction STLR 606, which acts as a one-way barrier. The STLR instruction 606 causes a target value to be stored to a memory location identified by the STLR instruction 606. Memory access instructions before the STLR are subject to an ordering requirement requiring that they are observed before the STLR instruction 606, but all memory access instructions after the STLR can be reordered with respect to the STLR. Therefore, memory access instruction 608 appearing after the STLR instruction 606 in program order may be reordered before the STLR instruction 606. However, memory access instruction 604 appearing before the STLR instruction 606 cannot be reordered after the STLR instruction 606.

FIG. 6 illustrates an ordering limit hint instruction 602 associated with the STLR instruction. The ordering limit hint instruction 602 in FIG. 6 is a release limit, and may be provided with its own opcode. The processing circuitry may associate the release limit instruction with the closest following STLR instruction in program order. The effect of the release limit is that memory access instructions appearing before the release limit in program order, such as memory access instruction 600, can be reordered after the STLR instruction 606 associated with that release limit instruction.

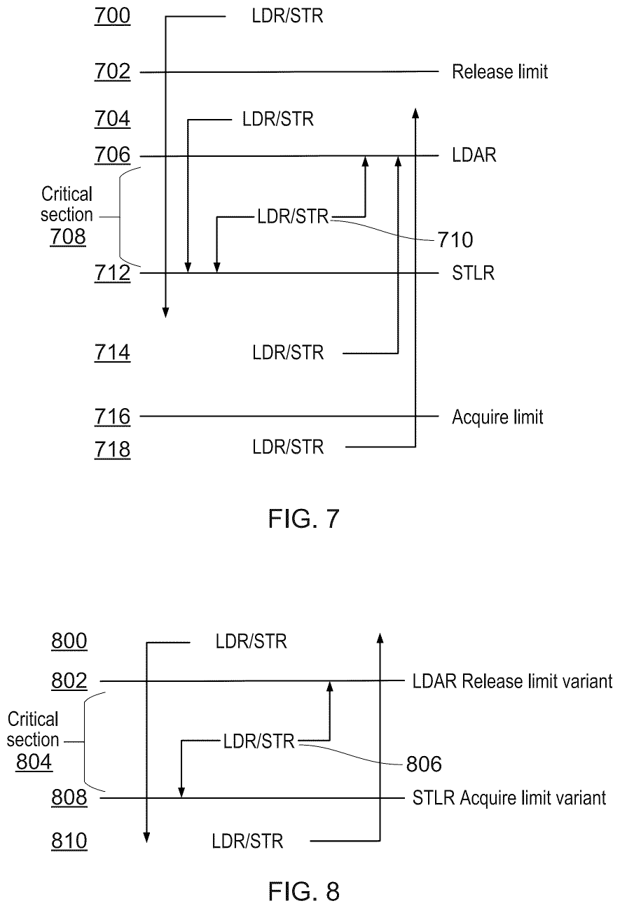

FIG. 7 illustrates a section of code using both a load-acquire instruction 706 and a store-release instruction 712. The LDAR instruction 706 and STLR instruction 712 define a critical section of code 708. The LDAR instruction 706 ensures that all memory accesses in the critical section 708 are observed after the load triggered by the LDAR instruction 706, because it ensures that all memory access instructions after the LDAR instruction 706 in program order are observed after the LDAR instruction 706. The STLR instruction 712 ensures that all memory accesses 710 in the critical section 708 are observed before the store triggered by the STRL instruction 712, because it ensures that all preceding memory access instructions are observed before the STRL instruction. Hence, all memory accesses 710 within the critical section cannot be reordered outside the critical section. Accesses 710 inside the critical section 708 can however be reordered with respect to each other.

A consequence of the STLR instruction 712 is that memory access instructions, such as memory access instruction 704, before the critical code section 708 are also prevented from being reordered with respect to the STLR instruction 712, even though this might not be necessary for correct execution.

Similarly, a consequence of the LDAR instruction 706 is that memory access instructions, such as memory access instruction 714, after the critical code section 708 are also prevented from being reordered with respect to the LDAR instruction, even though again this might not be necessary for correct execution. Therefore, the critical code section acts to unnecessarily block reordering of instructions, which can be associated with a performance reduction.

However, the blocking effects of the instructions surrounding the critical code section can be resolved by providing a release limit instruction 702 before the start of the critical code section, and an acquire limit 716 after the end of the critical code section. This allows a memory access instruction 700 before the critical code section (and before the release limit 702) to be reordered after the STLR at the end of the critical code section, and allows a memory access instruction 718 after the critical code section (and after the acquire limit 716) to be reordered before the LDAR 706 at the start of the critical code section.

FIG. 8 illustrates an example of a release limit variant of an LDAR instruction 802, and an acquire limit variant of an STLR instruction 808. As shown in FIG. 7, a critical code section 708 may be preceded by both an LDAR instruction 706 and a release limit instruction 702, and followed by both an STLR instruction 712 and an acquire limit instruction 716. To increase code density (and hence reduce storage requirements for code), some examples may provide a single instruction 802 which acts as both an LDAR instruction and a release limit instruction, and a single instruction 808 which acts as both an SLTR instruction and an acquire limit instruction. Therefore, the LDAR release limit variant 802 and STLR acquire limit variant 808 instructions may define a critical section of code 804, with the LDAR instruction 802 preventing memory access instructions 806 in the critical section 804 from being reordered before the LDAR instruction, and the STLR instruction 808 preventing memory access instructions 806 in the critical section 804 from being reordered after the STLR instruction. The LDAR release limit variant 802 defines the limit of the STLR instruction 808, such that any earlier memory access instruction 800 may be reordered beyond the STLR instruction 808. Similarly, the STLR acquire limit variant 808 defines the limit of the LDAR instruction 802, such that any later memory access instruction 810 may be reordered before the LDAR instruction 802.

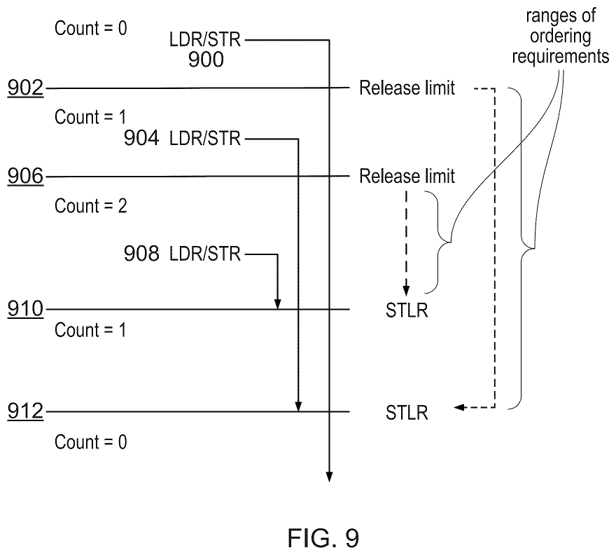

FIG. 9 illustrates an example implementation of a release limit instruction for limiting the range of a store-release instruction, as illustrated in FIG. 6.

FIG. 9 illustrates two nested pairs of release limit instructions and associated store-release instructions. Each release limit may be associated with the closest STLR instruction which is not associated with a closer release limit. The associations between release limits and STLR instructions are shown with dashed lines in FIG. 9. It will be seen that the effect of the nested release limits is that a memory access instruction 900 encountered before both release limits can be freely reordered, as the ordering requirement for both the first and second STLR instructions are relaxed before the first release limit 902. A memory access instruction 904 encountered after the first release limit is still subject to the ordering requirement of the second STLR 912, and therefore cannot be reordered beyond the second STLR 912, but is not within the ordering requirement of the first STLR 910 due to the release limit 906, and can therefore be reordered past the first STLR 910. A memory access instruction 908 encountered after both release limits and before the first STLR 910 is subject to both ordering requirements, and hence cannot be reordered beyond the first STLR 910. A memory access instruction encountered after the first STLR 910 will be subject to the ordering requirement only of the second SLTR 912, and cannot be reordered after the second STLR 912.

FIG. 9 illustrates the value of a hint counter associated with the store-release instruction. The hint counter is incremented each time a release limit instruction is encountered in program order, and is decremented each time an STLR instruction is encountered in program order. In this example, the processing circuitry is prevented from reordering a memory access instruction later in program order to a section of code associated with a count value lower than the count value at the time the memory access instruction was decoded.

For example, the count value starts at zero, is incremented to one when a first release limit 902 is encountered, is incremented further to two when a second release limit 904 is encountered, is then decremented to one when a first STLR is encountered 910 and is finally decremented back to zero when a second STLR 901 is encountered.

A memory access instruction 900 decoded whilst the count value is zero may be reordered to any position in the out-of-order window, as no section can have a lower count value. A memory access instruction 904 encountered after the first release limit 902 and before the second release limit 906 is associated with the count value of one, and can be reordered beyond the second release limit (as the count value of two after this point is not lower than the count value of one associated with instruction 904), and beyond the first STLR (as the count value of one after this point is not lower than the count value of one associated with instruction 904), but not beyond the second STLR 912, as instructions beyond this point have a count value of zero which is lower than the count value of one at the time of decoding instruction 904. A memory access instruction 908 encountered after the second release limit 906 is associated with a count value of two and can only be reordered until the first STLR, as all later sections of code are associated with a lower count value.

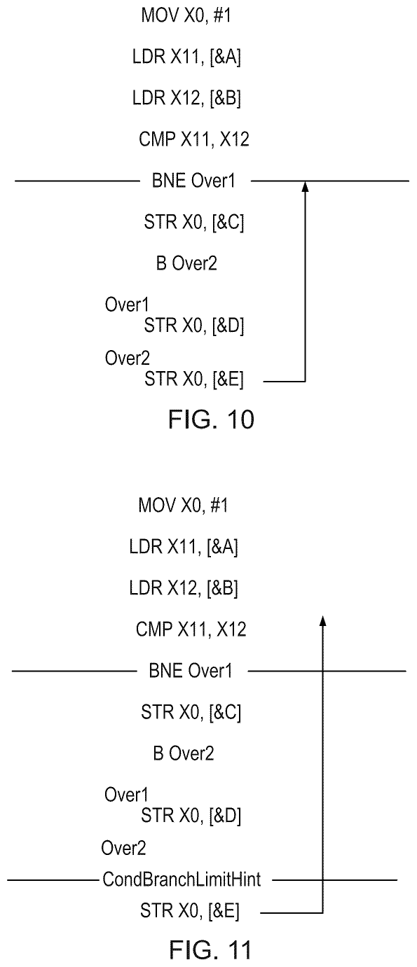

FIGS. 10 and 11 illustrate the use of an ordering limit hint instruction for limiting the range of an ordering requirement associated with a conditional control flow instruction.

A section of source code may have two conditional outcomes, as follows:

```
If A==B {
  C=1;
} else {
    D=1;
}
E=1 ;
```

The above source code sets the variable C to 1 if the variable A is equal to the value of variable B, and sets the variable D to 1 if A is not equal to B. In either case, the value of variable E is then set to 1.

FIG. 10 provides an example set of instructions compiled for implementing the above source code. The immediate value 1 is first written to register X0 by the move instruction MOV. The value associated with address A is loaded to register X11, and the value associated with address B is loaded to register X12. A compare instruction compares the values in registers X11 and X12 (comparing the values at addresses A and B), and sets some condition flags in a control register based on the outcome of the comparison. A conditional branch instruction BNE (branch if not equal) is then executed, having an outcome depending on the condition flags (and hence on the comparison of the values at A and B).

If the values are equal, then the BNE branch is not taken and a store instruction is executed to store the value in register X0 (the value 1) to address C, and the program then branches unconditionally to the position labelled Over2 at which point a store instruction writes the value in register X0 (the value 1) to address E.

If the values are not equal, then the BNE branch is taken to the position labelled Over1 and a store instruction is executed to store the value in register X0 (the value 1) to address D, and the program then proceeds to a further store instruction writes the value in register X0 (the value 1) to address E.

Therefore, in either case, a store instruction is executed causing the value in register X0 to be written to address E. However, the BNE branch instruction may be treated as an ordering instruction by the processing circuitry, preventing memory access instructions appearing later in program order from being reordered before the BNE branch instruction. This ordering requirement may prevent conditional memory access instructions on the not taken path being executed before the condition is evaluated, which can help to prevent incorrect execution. However, a consequence of the ordering requirement is that reordering may also be prevented for subsequent memory access instructions which occur after the conditional paths converge and which could be reordered before the conditional branch instruction without causing incorrect execution. For example, there is nothing to tell the hardware that it is OK to execute the store instruction causing the value in register X0 to be written to address E while the compare is outstanding (which might happen if either of the loads are delayed), and therefore performance might be unnecessarily reduced.

FIG. 11 illustrates the use of an ordering limit hint instruction, labelled CondBranchLimitHint, in the sequence of instructions illustrated in FIG. 10. The ordering limit hint instruction is inserted into the sequence after the paths from the most recent conditional branch instruction converge, indicating to the hardware that the STR X0, [&E] (and any later memory access instruction) is not conditional on the branch and can be reordered to before the branch instruction. It will be appreciated that the ordering requirement is still imposed on any memory access instruction between the conditional branch and the ordering limit hint instruction (i.e., the STR X0, [&C] and the STR X0, [&D]). Use of the ordering limit hint instruction can allow performance to be improved, because the STR X0, [&E] instruction can be executed whilst waiting for values to be returned from addresses A and B.

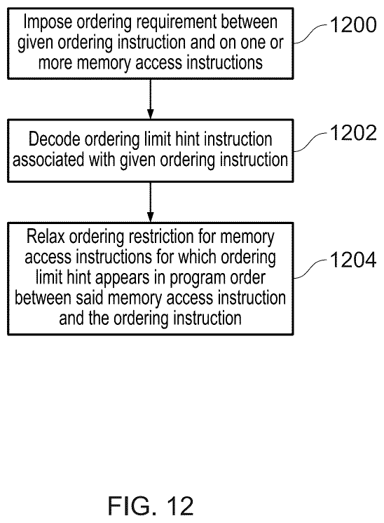

FIG. 12 is a flow diagram illustrating a method of imposing an ordering requirement. At step 1200, processing circuitry imposes an ordering requirement on one or more memory access instructions, to prevent those instructions being reordered with respect to a given ordering instruction.

At step 1202, the instruction decoding circuitry decodes an ordering limit hint instruction associated with the given ordering instruction.

At step 1204, the instruction decoding circuitry controls the processing circuitry to relax the ordering requirement for memory access instructions in the program for which the ordering limit hint instruction appears in program order between said memory access instruction and the ordering instruction associated with the ordering requirement. Hence, certain instructions which would have otherwise had the ordering requirement of step 1200 imposed may not have the ordering requirement imposed and may therefore be reordered with respect to the ordering instruction.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

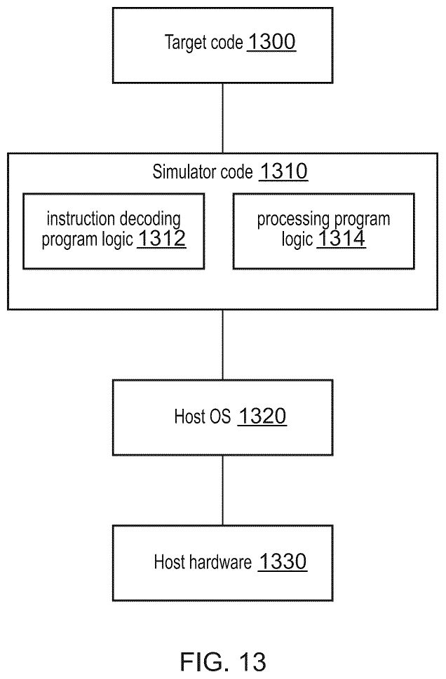

FIG. 13 illustrates a simulator implementation that may be used. Whilst the earlier described embodiments implement the present invention in terms of apparatus and methods for operating specific processing hardware supporting the techniques concerned, it is also possible to provide an instruction execution environment in accordance with the embodiments described herein which is implemented through the use of a computer program. Such computer programs are often referred to as simulators, insofar as they provide a software based implementation of a hardware architecture. Varieties of simulator computer programs include emulators, virtual machines, models, and binary translators, including dynamic binary translators. Typically, a simulator implementation may run on a host processor 1330, optionally running a host operating system 1320, supporting the simulator program 1310. In some arrangements, there may be multiple layers of simulation between the hardware and the provided instruction execution environment, and/or multiple distinct instruction execution environments provided on the same host processor. Historically, powerful processors have been required to provide simulator implementations which execute at a reasonable speed, but such an approach may be justified in certain circumstances, such as when there is a desire to run code native to another processor for compatibility or re-use reasons. For example, the simulator implementation may provide an instruction execution environment with additional functionality which is not supported by the host processor hardware, or provide an instruction execution environment typically associated with a different hardware architecture. An overview of simulation is given in “Some Efficient Architecture Simulation Techniques”, Robert Bedichek, Winter 1990 USENIX Conference, Pages 53-63.

To the extent that embodiments have previously been described with reference to particular hardware constructs or features, in a simulated embodiment, equivalent functionality may be provided by suitable software constructs or features. For example, particular circuitry may be implemented in a simulated embodiment as computer program logic. Similarly, memory hardware, such as a register or cache, may be implemented in a simulated embodiment as a software data structure. In arrangements where one or more of the hardware elements referenced in the previously described embodiments are present on the host hardware (for example, host processor 1330), some simulated embodiments may make use of the host hardware, where suitable.

The simulator program 1310 may be stored on a computer-readable storage medium (which may be a non-transitory medium), and provides a program interface (instruction execution environment) to the target code 1300 (which may include applications, operating systems and a hypervisor) which is the same as the interface of the hardware architecture being modelled by the simulator program 1310. Thus, the program instructions of the target code 1300, including may be executed from within the instruction execution environment using the simulator program 1310, so that a host computer 1330 which does not actually have the hardware features of the apparatus 2 discussed above can emulate these features.

Therefore, instruction decoding program logic 1312 and processing program logic 1314 may be provided by the simulator code 1310 to control the host hardware 1330 to provide the functionality of the instruction decoding circuitry 10 and the processing circuitry 16 discussed above.

Some examples are set out in the following clauses:

1. An apparatus, comprising:
processing circuitry configured to perform data processing; and
instruction decoding circuitry configured to decode instructions to control the processing circuitry to perform the data processing; in which:
the processing circuitry is configured to impose an ordering requirement on one or more memory access instructions to prevent said one or more memory access instructions being reordered with respect to an ordering instruction; and
in response to an ordering limit hint instruction associated with a given ordering instruction, the instruction decoding circuitry is configured to control the processing circuitry to relax the ordering requirement for a memory access instruction for which the ordering limit hint instruction appears in program order between the memory access instruction and the given ordering instruction.

2. The apparatus according to clause 1, wherein an encoding of the ordering limit hint instruction enables the given ordering instruction to be identified.

3. The apparatus according to clause 2, wherein the encoding of the ordering limit hint instruction identifies whether the given ordering instruction appears in program order earlier or later than the ordering limit hint instruction.

4. The apparatus according to any of clauses 2 and 3, wherein the encoding of the ordering limit hint instruction identifies an instruction type of the given ordering instruction.

5. The apparatus according to any preceding clause, wherein the processing circuitry is configured to associate the ordering limit hint instruction with a limited-ordering ordering instruction; and
the instruction decoding circuitry is responsive to a limited ordering prefix instruction to identify that a subsequent ordering instruction is a limited-ordering ordering instruction.

6. The apparatus according to any preceding clause, wherein the processing circuitry is configured to treat at least one type of memory barrier instruction as the ordering instruction, and the processing circuitry is configured to impose the ordering requirement on memory access instructions appearing in program order on a first side of the memory barrier instruction.

7. The apparatus according to clause 6, wherein relaxing the ordering requirement for a given memory access instruction appearing in program order on the first side of the memory barrier instruction comprises permitting the given memory access instruction to be reordered to a second side of the memory barrier instruction.

8. The apparatus according to any of clauses 6 and 7, wherein the at least one type of memory barrier instruction comprises a general memory barrier instruction, and the processing circuitry is configured to also impose the ordering requirement on memory access instructions appearing in program order on a second side of the general memory barrier instruction.

9. The apparatus according to any of clauses 6 to 8, wherein the at least one type of memory barrier instruction comprises an acquire instruction, the processing circuitry is configured to impose the ordering requirement on memory access instructions appearing in program order after the acquire instruction, and
the processing circuitry is configured to relax the ordering requirement for memory access instructions appearing in program order after an ordering limit hint instruction associated with the acquire instruction.

10. The apparatus according to clause 9, wherein the at least one type of memory barrier instruction further comprises an ordering limit variant of a release instruction; wherein
the processing circuitry is configured to impose an ordering requirement on memory access instructions appearing in program before the ordering limit variant of the release instruction to prevent said memory access instructions being reordered with respect to the ordering limit variant of the release instruction; and
the processing circuitry is configured to treat the ordering limit variant of the release instruction as the ordering limit hint instruction associated with an acquire instruction appearing earlier in program order than the ordering limit variant of the release instruction.

11. The apparatus according to any of clauses 6 to 10, wherein the at least one type of memory barrier instruction comprises a release instruction, the processing circuitry is configured to impose the ordering requirement on memory access instructions appearing in program order before the release instruction, and
the processing circuitry is configured to relax the ordering requirement for memory access instructions appearing in program order before an ordering limit hint instruction associated with the release instruction.

12. The apparatus according to clause 11, wherein the at least one type of memory barrier instruction further comprises an ordering limit variant of an acquire instruction; wherein
the processing circuitry is configured to impose an ordering requirement on memory access instructions appearing in program after the ordering limit variant of the acquire instruction to prevent said memory access instructions being reordered with respect to the ordering limit variant of the acquire instruction; and
the processing circuitry is configured to treat the ordering limit variant of the acquire instruction as the ordering limit hint instruction associated with a release instruction appearing later in program order than the ordering limit variant of the acquire instruction.

13. The apparatus according to any preceding clause, wherein the processing circuitry is configured to treat at least one type of conditional control flow instruction as the ordering instruction.

14. The apparatus according to any preceding clause, comprising:
a hint counter associated with the given ordering instruction; and
hint tracking circuitry configured to update the hint counter in response to the instruction decoding circuitry decoding the ordering limit hint instruction associated with the given ordering instruction; wherein
the processing circuitry is configured to select whether to impose the ordering requirement on a given memory access instruction based on a value of the hint counter at a time the given memory access instruction is decoded by the instruction decoding circuitry.

15. The apparatus according to clause 14, wherein the hint counter comprises at least three states.

16. The apparatus according to any preceding clause, wherein the processing circuitry is responsive to a hint clear trigger to suppress the effects of the ordering limit hint instruction associated with the given ordering instruction.

17. The apparatus according to any preceding clause, wherein the ordering limit hint instruction is encoded within a no-operation space of a legacy instruction set architecture supported by the instruction decoding circuitry.

18. Computer-readable code for fabrication of the apparatus according to any preceding clause.

19. A method, comprising:
performing data processing; and
decoding instructions to control performing the data processing;
imposing an ordering requirement on one or more memory access instructions to prevent said one or more memory access instructions being reordered with respect to an ordering instruction; and
in response to an ordering limit hint instruction associated with a given ordering instruction, relaxing the ordering requirement for a memory access instruction for which the ordering limit hint instruction appears in program order between the memory access instruction and the given ordering instruction.

20. A computer program comprising instructions which, when executed by a host data processing apparatus, control the host data processing apparatus to provide an instruction execution environment for execution of target program code, the computer program comprising:
processing program logic configured to perform data processing; and
instruction decoding program logic configured to decode instructions of the target program code to control the processing program logic to perform the data processing; in which:
the processing program logic is configured to impose an ordering requirement on one or more memory access instructions to prevent said one or more memory access instructions being reordered with respect to an ordering instruction; and
in response to an ordering limit hint instruction associated with a given ordering instruction, the instruction decoding program logic is configured to control the processing program logic to relax the ordering requirement for a memory access instruction for which the ordering limit hint instruction appears in program order between the memory access instruction and the given ordering instruction.

In summary, an apparatus comprises processing circuitry to perform data processing and instruction decoding circuitry to decode instructions to control the processing circuitry. The processing circuitry imposes an ordering requirement on one or more memory access instructions to prevent said one or more memory access instructions being reordered with respect to an ordering instruction. In response to an ordering limit hint instruction associated with a given ordering instruction, the processing circuitry relaxes the ordering requirement for a memory access instruction for which the ordering limit hint instruction appears in program order between the memory access instruction and the given ordering instruction.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: A, B and C” encompasses any of the following options: A alone (without B or C), B alone (without A or C), C alone (without A or B), A and B in combination (without C), A and C in combination (without B), B and C in combination (without A), or A, B and C in combination.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. An apparatus, comprising:
processing circuitry configured to perform data processing; and
instruction decoding circuitry configured to decode instructions to control the processing circuitry to perform the data processing; in which:
the processing circuitry is configured to impose an ordering requirement on one or more memory access instructions to prevent said one or more memory access instructions being reordered with respect to an ordering instruction; and
in response to an ordering limit hint instruction associated with a given ordering instruction, the instruction decoding circuitry is configured to control the processing circuitry to relax the ordering requirement for a memory access instruction for which the ordering limit hint instruction appears in program order between the memory access instruction and the given ordering instruction.

2. The apparatus according to claim 1, wherein an encoding of the ordering limit hint instruction enables the given ordering instruction to be identified.

3. The apparatus according to claim 2, wherein the encoding of the ordering limit hint instruction identifies whether the given ordering instruction appears in program order earlier or later than the ordering limit hint instruction.

4. The apparatus according to claim 2, wherein the encoding of the ordering limit hint instruction identifies an instruction type of the given ordering instruction.

5. The apparatus according to claim 1, wherein the processing circuitry is configured to associate the ordering limit hint instruction with a limited-ordering ordering instruction; and
the instruction decoding circuitry is responsive to a limited ordering prefix instruction to identify that a subsequent ordering instruction is a limited-ordering ordering instruction.

6. The apparatus according to claim 1, wherein the processing circuitry is configured to treat at least one type of memory barrier instruction as the ordering instruction, and the processing circuitry is configured to impose the ordering requirement on memory access instructions appearing in program order on a first side of the memory barrier instruction.

7. The apparatus according to claim 6, wherein relaxing the ordering requirement for a given memory access instruction appearing in program order on the first side of the memory barrier instruction comprises permitting the given memory access instruction to be reordered to a second side of the memory barrier instruction.

8. The apparatus according to claim 6, wherein the at least one type of memory barrier instruction comprises a general memory barrier instruction, and the processing circuitry is configured to also impose the ordering requirement on memory access instructions appearing in program order on a second side of the general memory barrier instruction.

9. The apparatus according to claim 6, wherein the at least one type of memory barrier instruction comprises an acquire instruction, the processing circuitry is configured to impose the ordering requirement on memory access instructions appearing in program order after the acquire instruction, and
the processing circuitry is configured to relax the ordering requirement for memory access instructions appearing in program order after an ordering limit hint instruction associated with the acquire instruction.

10. The apparatus according to claim 9, wherein the at least one type of memory barrier instruction further comprises an ordering limit variant of a release instruction; wherein
the processing circuitry is configured to impose an ordering requirement on memory access instructions appearing in program before the ordering limit variant of the release instruction to prevent said memory access instructions being reordered with respect to the ordering limit variant of the release instruction; and
the processing circuitry is configured to treat the ordering limit variant of the release instruction as the ordering limit hint instruction associated with an acquire instruction appearing earlier in program order than the ordering limit variant of the release instruction.

11. The apparatus according to claim 6, wherein the at least one type of memory barrier instruction comprises a release instruction, the processing circuitry is configured to impose the ordering requirement on memory access instructions appearing in program order before the release instruction, and
the processing circuitry is configured to relax the ordering requirement for memory access instructions appearing in program order before an ordering limit hint instruction associated with the release instruction.

12. The apparatus according to claim 11, wherein the at least one type of memory barrier instruction further comprises an ordering limit variant of an acquire instruction; wherein
the processing circuitry is configured to impose an ordering requirement on memory access instructions appearing in program after the ordering limit variant of the acquire instruction to prevent said memory access instructions being reordered with respect to the ordering limit variant of the acquire instruction; and
the processing circuitry is configured to treat the ordering limit variant of the acquire instruction as the ordering limit hint instruction associated with a release instruction appearing later in program order than the ordering limit variant of the acquire instruction.

13. The apparatus according to claim 1, wherein the processing circuitry is configured to treat at least one type of conditional control flow instruction as the ordering instruction.

14. The apparatus according to claim 1, comprising:
a hint counter associated with the given ordering instruction; and
hint tracking circuitry configured to update the hint counter in response to the instruction decoding circuitry decoding the ordering limit hint instruction associated with the given ordering instruction; wherein
the processing circuitry is configured to select whether to impose the ordering requirement on a given memory access instruction based on a value of the hint counter at a time the given memory access instruction is decoded by the instruction decoding circuitry.

15. The apparatus according to claim 14, wherein the hint counter comprises at least three states.

16. The apparatus according to claim 1, wherein the processing circuitry is responsive to a hint clear trigger to suppress the effects of the ordering limit hint instruction associated with the given ordering instruction.

17. The apparatus according to claim 1, wherein the ordering limit hint instruction is encoded within a no-operation space of a legacy instruction set architecture supported by the instruction decoding circuitry.

18. A non-transitory computer-readable medium storing computer-readable code for fabrication of the apparatus according to claim 1.

19. A method, comprising:
performing data processing; and
decoding instructions to control performing the data processing;
imposing an ordering requirement on one or more memory access instructions to prevent said one or more memory access instructions being reordered with respect to an ordering instruction; and
in response to an ordering limit hint instruction associated with a given ordering instruction, relaxing the ordering requirement for a memory access instruction for which the ordering limit hint instruction appears in program order between the memory access instruction and the given ordering instruction.

20. A non-transitory computer-readable medium storing a computer program comprising instructions which, when executed by a host data processing apparatus, control the host data processing apparatus to provide an instruction execution environment for execution of target program code, the computer program comprising:
processing program logic configured to perform data processing; and
instruction decoding program logic configured to decode instructions of the target program code to control the processing program logic to perform the data processing; in which:
the processing program logic is configured to impose an ordering requirement on one or more memory access instructions to prevent said one or more memory access instructions being reordered with respect to an ordering instruction; and
in response to an ordering limit hint instruction associated with a given ordering instruction, the instruction decoding program logic is configured to control the processing program logic to relax the ordering requirement for a memory access instruction for which the ordering limit hint instruction appears in program order between the memory access instruction and the given ordering instruction.
